(19) United States
(12) Patent Application Publication
(10) Pub. No.: US 2015/0037076 A1
(43) Pub. Date: Feb. 5, 2015

(54) FIXING APPARATUS AND IMAGE FORMING APPARATUS

(71) Applicants: TOSHIBA TEC KABUSHIKI KAISHA, Tokyo (JP); KABUSHIKI KAISHA TOSHIBA, Tokyo (JP)

(72) Inventor: Noboru FURUYAMA, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/069,805

(22) Filed: Nov. 1, 2013

(30) Foreign Application Priority Data
Jul. 31, 2013 (JP) 2013-158926

(51) Int. Cl. G03G 15/20

(52) U.S. Cl. CPC G03G 15/2085
USPC 399/329

(57) ABSTRACT

A fixing apparatus includes a pressing unit, a belt unit disposed to be pressed by the pressing unit and including a conductive layer, and a magnetic flux generation unit configured to generate a magnetic flux that causes the conductive layer to generate heat. The conductive layer has ends that are disposed inwardly of regions of the belt unit that contact ends of the pressing unit while the pressing unit rotates.

### CROSS-REFERENCE TO RELATED APPLICATION

This application is based upon and claims the benefit of priority from Japanese Patent Application No. 2013-158926, filed Jul. 31, 2013, the entire contents of which are incorporated herein by reference.

### FIELD

Embodiments described herein relate to a fixing apparatus and an image forming apparatus.

### BACKGROUND

There is an image forming apparatus, such as a copier or printer, having a fixing apparatus which heats a fixing belt by causing a heating layer included in the fixing belt to generate heat through electromagnetic induction heating (IH). In such a fixing apparatus, the heating layer extends to an end portion of the fixing belt in a longitudinal direction. However, the heating layer at the end portion of the fixing belt may be damaged while the fixing belt is repeatedly pressed by a pressing unit of the fixing apparatus and released from the press of the pressing unit.

### BRIEF DESCRIPTION OF THE DRAWINGS

FIG. 1 is a schematic diagram illustrating a multi-function peripheral (MFP) as an example of an image forming apparatus according to an embodiment.

FIG. 2 is a schematic diagram illustrating a fixing apparatus according to the embodiment observed from a lateral side.

FIG. 3 is a schematic diagram illustrating a fixing apparatus according to the embodiment observed from a longitudinal direction.

FIG. 4 is a schematic diagram illustrating a layer structure of a fixing belt in the fixing apparatus according to the embodiment.

### DETAILED DESCRIPTION

In accordance with one embodiment, a fixing apparatus includes a pressing unit, a belt unit disposed to be pressed by the pressing unit and including a conductive layer, and a magnetic flux generation unit configured to generate a magnetic flux that causes the conductive layer to generate heat. The conductive layer has ends that are disposed inwardly of regions of the belt unit that contact ends of the pressing unit while the pressing unit rotates.

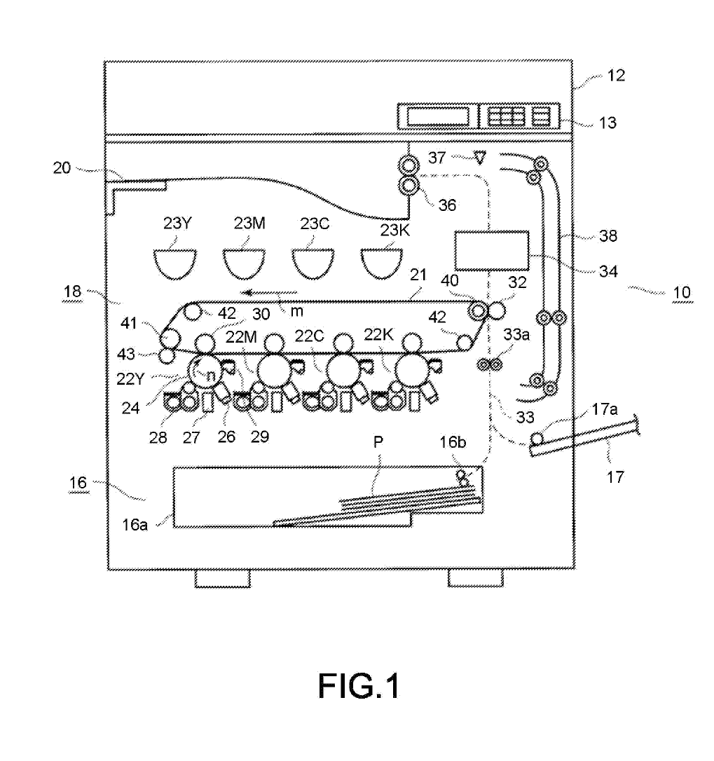

Embodiments of the present invention are described in detail below with reference to accompanying drawings of FIG. 1-FIG. 4. FIG. 1 illustrates an MFP (Multi-Function Peripherals) 10 as an example of an image forming apparatus according to an embodiment. The MFP 10 comprises, for example, a scanner 12, a control panel 13, a paper feed cassette section 16, a manual feed tray 17, a printer section 18, and a paper discharging section 20.

The scanner 12 reads an original image for the printer section 18 to form an image. The control panel 13 accepts an input from, for example, a user or display information for a user.

The paper feed cassette section 16 comprises a paper feeding cassette 16a for storing a sheet P serving as a recording medium and a pickup roller 16b for picking up a sheet P from the paper feeding cassette 16a. The sheet P includes an unused sheet or a sheet for reuse (e.g. a sheet an image on which has been erased through a color erasing processing) and the like. The manual feed tray 17 is capable of feeding an unused sheet P or a sheet P for reuse with a pickup roller 17a.

The printer section 18 comprises an intermediate transfer belt 21. In the printer section 18, the intermediate transfer belt 21 is supported by a backup roller 40 having a driving section, a driven roller 41, and a tension roller 42, and configured to rotate in a direction indicated by an arrow m.

The printer section 18 comprises Y (yellow), M (magenta), C (cyan) and K (black) image forming stations 22Y, 22M, 22C, and 22K, which are arranged in parallel along the lower side of the intermediate transfer belt 21. The printer section 18 comprises replenishing cartridge 23Y, 23M, 23C, and 23K above the image forming stations 22Y, 22M, 22C, and 22K to store toners to be replenished, respectively.

For example, the Y (yellow) image forming station 22Y includes a charger 26, an exposure scanning head 27, a developing apparatus 28, and a photoconductor cleaner 29, around a photoconductive drum 24 rotating in a direction indicated by an arrow n. The Y (yellow) image forming station 22Y has a primary transfer roller 30, which is located at a position opposite to the photoconductive drum 24 with the intermediate transfer belt 21 therebetween.

The M (magenta), C (cyan), and K (black) image forming stations 22M, 22C, and 22K have the same configuration as that of the Y (yellow) image forming station 22Y. Therefore, detailed description of the M (magenta), C (cyan), and K (black) image forming stations 22M, 22C, and 22K is omitted.

In the image forming stations 22Y, 22M, 22C, and 22K, the photoconductive drum 24, after being charged by the charger 26, is exposed by the exposure scanning head 27, thereby forming electrostatic latent images on the photoconductive drum 24. The developing apparatus 28 develops the electrostatic latent images on the photoconductive drum 24 with a two-component developing agent including Y (yellow), M (magenta), C (cyan), and K (black) toners and a carrier. The toner for development may be, for example, a color non-erasable toner or a color erasable toner, which can be erased when heated to a given temperature, and the like.

The primary transfer roller 30 primarily transfers a toner image formed on the photoconductive drum 24 to the intermediate transfer belt 21. The image forming stations 20Y, 20M, 20C, and 22K forms a color toner image on the intermediate transfer belt 21 by overlapping Y (yellow), M (magenta), C (cyan), and K (black) toner images with the primary transfer rollers 30. The photoconductor cleaner 29 removes the toner left on the photoconductive drum 24 after the primary transfer.

The printer section 18 includes a secondary transfer roller 32 which is located at a position opposite to the backup roller 40 with the intermediate transfer belt 21 therebetween. The secondary transfer roller 32 secondarily transfers all the color toner images on the intermediate transfer belt 21 to a sheet P. The sheet P is fed from the paper feed cassette section 16 or the manual feed tray 17 along a conveyance path 33 in synchronization with a conveyance of the color toner image on the intermediate transfer belt 21. A belt cleaner 43 removes the toner left on the intermediate transfer belt 21 after the secondary transfer.

The printer section 18 includes a register roller 33a, a fixing apparatus 34, and a paper discharging roller 36 along the conveyance path 33. The printer section 18 further includes a bifurcation unit 37 and a reversal conveyance unit 38 at a position downstream with respect to the fixing apparatus 34 in a direction of sheet conveyance. The bifurcation section 37 distributes the sheet P towards the paper discharging section 20 or the reversal conveyance section 38. In the case of a duplex printing, the reversal conveyance section 38 conveys the sheet P distributed from the bifurcation section 37 towards the register roller 33a.

The intermediate transfer belt 21, the image forming stations 22Y, 22M, 22C, and 22K, and the secondary transfer roller 32 constitute an image forming section.

With such a configuration, the MFP 10 forms a fixed toner image on a sheet P using the printer section 18 and discharges the sheet P to the paper discharging section 20.

The image forming apparatus is not limited to the MFP 10. The image forming apparatus is not limited to a tandem form, and no limitation is given to the number of the developing apparatuses. The image forming apparatus may transfer a toner image directly from a photoconductor to a recording medium.

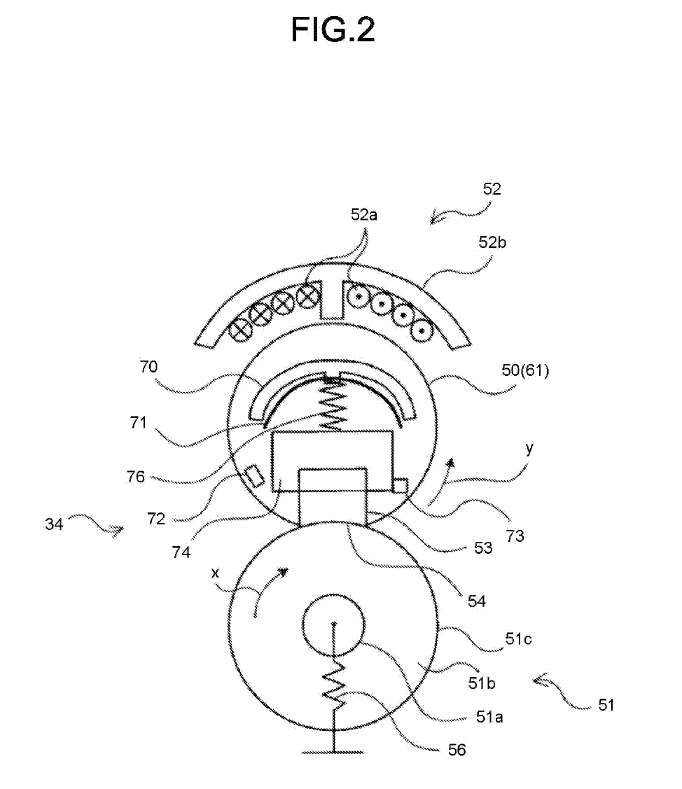

Next, the fixing apparatus 34 is described below in detail. As shown in FIG. 2, the fixing apparatus 34 comprises an endless fixing belt 50 having a conductive layer 61 serving as a heating layer, a press roller 51 serving as a pressing unit, and an electromagnetic induction heating coil unit (hereinafter referred to as an IH coil unit for short) 52 serving as a generating unit.

In a space within the fixing belt 50, a press pad 53 serving as a support unit, a magnetic shunt alloy 70, and a shield 71 including an aluminum are disposed. Further, in the space within the fixing belt 50, a temperature sensor 72 for detecting a temperature of the fixing belt 50 and a thermostat 73 for detecting an abnormal heating of the fixing belt 50 are disposed. Moreover, in the space, a frame 74 for supporting the press pad 53 is disposed. The frame 74 supports a support spring 76 which adjusts the position of the shield 71.

The press pad 53 is located at a position opposite to the press roller 51 with the fixing belt 50 therebetween. The press pad 53 urges an inner peripheral surface of the fixing belt 50 towards the press roller 51. The press roller 51 presses the fixing belt 50 urged by the press pad 53 to form a nip 54 between the fixing belt 50 and press roller 51. The press pad 53 is made from, for example, heat-resistant polyphenylene sulfide resin (PPS). A sliding sheet, which is formed, for example, by coating fluororesin on the surface of glass fiber, may be arranged between the press pad 53 and the fixing belt 50 to reduce a friction resistance between the fixing belt 50 and the press pad 53.

Magnetic characteristics of the magnetic shunt alloy 70 change in accordance with temperature. As permeability of the magnetic shunt alloy 70 decreases at a temperature higher than a Curie point temperature, density of magnetic flux passing the fixing belt 50 decreases, and, thus, the heat generated from the fixing belt 50 decreases. By reducing the heat value of the fixing belt 50, the magnetic shunt alloy 70 can restrict the temperature rise of the fixing belt 50 in, for example, a non-paper passing area of the fixing belt 50. When temperature is below the Curie point temperature, the magnetic shunt alloy 70 generates heat with the magnetic flux from the IH coil unit 52 and assists the fixing belt 50 in generating heat.

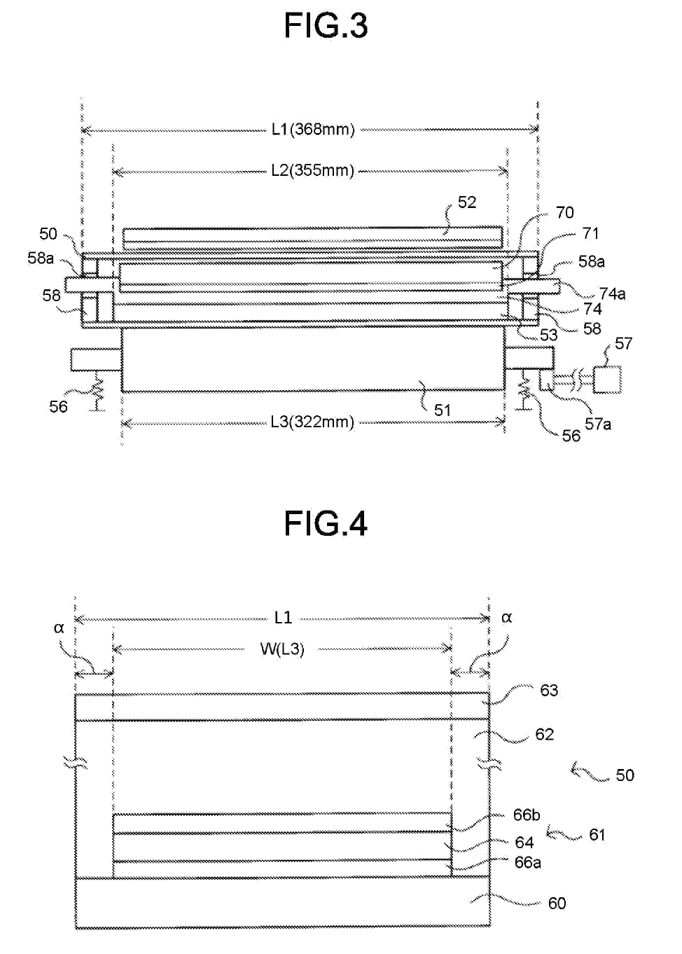

The press roller 51 has an elastic layer 51b, such as a heat-resistant rubber layer, around a core bar 51a and a release layer 51c including fluororesin on the surface of the press roller 51. The press roller 51 is in contact with the fixing belt 50 under the pressure of a press spring 56. As shown in FIG. 3, in the fixing apparatus 34, a motor 57 drives the press roller 51 with a gear 57a, and the fixing belt 50 is driven by the press roller 51.

A wheel 58, which keeps the fixing belt 50 substantially in a circular shape, is arranged on the inner periphery at ends of the fixing belt 50. The wheel 58 supports a frame shaft 74a with a bearing 58a therebetween. The fixing belt 50 that is in contact with the press roller 51 at the position of the press pad 53 is driven by the press roller 51 to rotate integrally with the wheel 58. The fixing belt 50 may also be driven to rotate independently from the press roller 51. When the fixing belt 50 is independently driven to rotate, a one-way clutch may be inserted to prevent a difference of speed between the fixing belt 50 and the press roller 51.

The middle area of the fixing belt 50 in a longitudinal direction (a direction parallel to a rotation axis) is in a tension-free state. The middle area of the fixing belt 50 in the longitudinal direction is in contact with the press roller 51 at the position of the press pad 53 and is therefore deformed.

In the longitudinal direction, for example, a width (L1) of the fixing belt 50 is 368 mm, a width (L2) of the press pad 53 is 355 mm, and a width (L3) of the press roller 50 is 332 mm. For example, the width (L2) of the press pad 53 is slightly greater than the maximum fixing width of the fixing apparatus 34.

The IH coil unit 52 comprises a core 52b which covers a coil 52a and the periphery of the coil 52a and regulates the magnetic flux of the coil 52a. In the IH coil unit 52, a high-frequency current is applied to the coil 52a to generate a magnetic flux in the direction of the fixing belt 50. The conductive layer 61 of the fixing belt 50 generates an eddy current in accordance with the magnetic flux from the IH coil unit 52, and generates heat.

The fixing belt 50 is a multi-layer structure including the conductive layer 61. As shown in FIG. 4, the fixing belt 50 comprises, for example, from the inner periphery side to the outer periphery side, an endless base material 60, the conductive layer 61 serving as a heating layer, an elastic layer 62, and a toner release layer 63. No limitation is given to the layer structure of the fixing belt 50 as long as the fixing belt 50 comprises the conductive layer 61. The base material 60 is, for example, a polyimide sleeve having a thickness of 70 μm.

The conductive layer 61 includes, for example, a Cu layer having a thickness of 10 μm. The conductive layer 61 comprises a Nickel (Ni) layer 66a having a thickness of 1 μm and a Nickel (Ni) layer 66b having a thickness of 8 μm with the Cu layer 64 therebetween. As long as the conductive layer 61 generates heat in accordance with the magnetic flux from the IH coil unit 52, then the conductive layer may be a single Fe, Nickel (Ni) or Cu layer. The elastic layer 62 is, for example, a Silicon (Si) rubber layer having a thickness of 200 μm, and the toner release layer 63 is, for example, a fluroresin (e.g., PFA resin) tube having a thickness of 30 μm. In order to enables a fast warming up, the conductive layer 61 is preferably reduced in thickness and heat capacity.

A width (W) of the conductive layer 61 in the longitudinal direction is, for example, equal to the width L3 of the press roller 51. The conductive layer 61 does not extend to an area α outside the contact area of the press roller 51 and the fixing belt 50, that is, the nip 54, which has a width of L3. No limitation is given to the width (W) of the conductive layer 61 as long as the conductive layer 61 does not extend to a region outside the nip 54 (width L3) and causes no damage to the heat generation performance of the fixing belt 50. As the conductive layer 61 does not extend to a region outside the nip area, the conductive layer 61 is prevented from being deformed even if the middle area of the fixing belt 50, of which end parts are kept in circular shape by the wheel 58, is deformed at the position of the press pad 53. If the conductive layer 61 is formed on the surface of the base material 60 through deposition or plating, then the conductive layer 61 is formed while the areas a at two ends of the base material 60 are masked.

When the press roller 51 rotates in the direction indicated by an arrow x as shown in FIG. 2, the fixing belt 50 is driven to rotate in the direction indicated by an arrow y. When a portion of the area α, which is between the wheel 58 and the end parts of the press roller 51, is in a position opposite to the press roller 51, the portion of the area α 51 is deformed as the press contact stress generated by the end part of the press roller 51 is concentrated in the portion of the area α. After the fixing belt 50 passes through the nip 54, the portion of the area α of the fixing belt 50 is released from the press contact stress generated by the end parts of the press roller 51, and the portion of the area α stretches.

When the fixing belt 50 is driven to rotate in the direction indicated by the arrow y, the area α of the fixing belt 50 is repeatedly deformed under the press contact stress generated by the end parts of the press roller 51 and then stretches. However, the conductive layer 61 at a position within the areas a generates few cracks as the conductive layer 61 is little influenced by the press contact stress generated by the end parts of the press roller 51. The fixing belt 50 more reliably generates heat even at the end part of the nip 54. The fixing apparatus 34 can achieve an excellent fixation in the whole width of the sheet P, without generating a poor fixation at the end part of the nip 54.

As a comparative example, a fixing belt formed with a conductive layer formed as far as the end part in the longitudinal direction was examined in a life test. In the comparative example, a crack occurred in the conductive layer during the period in which the end parts of the fixing belt were repeatedly deformed and stretch due to the press contact stress generated by the end parts of a press roller at the ends of the nip. Further, when the end parts of the fixing belt were deformed and stretch repeatedly, the crack generated in the conductive layer extended to a fixing area and the heat generated at the fixing belt was reduced. In the comparative example, a crack extended from a part of the conductive layer that corresponds to the end part of the press roller to the entire conductive layer, which lead to a poor fixation due to poor heat generation.

According to the embodiments described herein, the conductive layer 61 of the fixing belt 50 does not extend to the area α outside the area that will be in contact with the press roller 51. The conductive layer 61 is less influenced by the press contact stress generated by the end parts of the press roller 51 even if the area α at the end parts of the fixing belt 50 is repeatedly deformed and stretches due to the press contact stress generated by the press roller 51. The fixing belt 50 can prevent the generation of a crack in the conductive layer 61. The fixing apparatus 34 prevents a poor fixation caused by the crack generated in the conductive layer 61 of the fixing belt 50 and therefore achieves an excellent fixation.

The present invention is not limited to the embodiments above which may have various variations. In the embodiments described herein, the end part of the fixing belt is kept in a circular shape by the wheel; however, the present invention is not limited to this. The fixing belt may be stretched by a plurality of rollers. Further, the press section may be in a belt shape, but is not limited to be in a roller shape.

While certain embodiments have been described, these embodiments have been presented by way of example only, and are not intended to limit the scope of the invention. Indeed, the novel embodiments described herein may be embodied in a variety of other forms. Furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A fixing apparatus, comprising:
a pressing unit;
a belt unit disposed to be pressed by the pressing unit and including a conductive layer having ends that are disposed inwardly of regions of the belt unit that contact ends of the pressing unit while the pressing unit rotates; and
a magnetic flux generation unit configured to generate a magnetic flux that causes the conductive layer to generate heat.

2. The fixing apparatus according to claim 1, wherein the conductive layer extends in a direction of a rotational axis of the pressing unit, and a length of the conductive layer in the direction is equal to or less than a length of the pressing unit in the direction.

3. The fixing apparatus according to claim 1, further comprising:
an urging unit configured to urge a portion of the belt unit towards the pressing unit,
wherein the pressing unit has ends that are disposed inwardly of regions of the belt unit that contacts ends of the urging unit while the pressing unit rotates.

4. The fixing apparatus according to claim 1, further comprising:
an urging unit configured to urge a portion of the belt unit towards the pressing unit and extending in a direction of a rotational axis of the pressing unit,
wherein a length of the pressing unit in the direction is equal to or less than a length of the urging unit in the direction.

5. The fixing apparatus according to claim 4, wherein the length of the urging unit in the direction is less than a length of the belt unit in the direction.

6. The fixing apparatus according to claim 1, wherein a portion of the belt unit deforms in accordance with the shape of the pressing unit when the belt unit is pressed against the pressing unit.

7. The fixing apparatus according to claim 1, wherein the urging unit includes a shaft that extends in a direction of a rotational axis of the pressing unit, and the belt unit is configured to rotate around the shaft.

8. An image forming apparatus, comprising:
an image forming unit configured to form an image on a medium; and
a fixing apparatus configured to fix the image onto the medium, the fixing apparatus including,
a pressing unit,
a belt unit disposed to be pressed by the pressing unit and including a conductive layer having ends that are disposed inwardly of regions of the belt unit that contact ends of the pressing unit while the pressing unit rotates, and
a magnetic flux generation unit configured to generate a magnetic flux that causes the conductive layer to generate heat.

9. The image forming apparatus according to claim 8, wherein the conductive layer extends in a direction of a rotational axis of the pressing unit, and a length of the conductive layer in the direction is equal to or less than a length of the pressing unit in the direction.

10. The image forming apparatus according to claim 8, wherein the fixing apparatus further includes an urging unit configured to urge a portion of the belt unit towards the pressing unit, and the pressing unit has ends that are disposed inwardly of regions of the belt unit that contacts ends of the urging unit while the pressing unit rotates.

11. The image forming apparatus according to claim 8, wherein the fixing apparatus further includes an urging unit configured to urge a portion of the belt unit towards the pressing unit and extending in a direction of a rotational axis of the pressing unit, and a length of the pressing unit in the direction is equal to or less than a length of the urging unit in the direction.

12. The image forming apparatus according to claim 11, wherein the length of the urging unit in the direction is less than a length of the belt unit in the direction.

13. The image forming apparatus according to claim 8, wherein a portion of the belt unit deforms in accordance with the shape of the pressing unit when the belt unit is pressed against the pressing unit.

14. The image forming apparatus according to claim 8, wherein the urging unit includes a shaft that extends in a direction of a rotational axis of the pressing unit, and the belt unit is configured to rotate around the shaft.

15. A fixing apparatus, comprising:
a pressing unit;
a belt unit disposed to be pressed by the pressing unit and including a conductive layer that extends in a direction of a rotational axis of the pressing unit, a length of the conductive layer in the direction is being equal to or less than a length of the pressing unit in the direction; and
a magnetic flux generation unit configured to generate a magnetic flux that causes the conductive layer to generate heat.

16. The fixing apparatus according to claim 15, further comprising:
an urging unit configured to urge a portion of the belt unit towards the pressing unit,
wherein the pressing unit has ends that are disposed inwardly of regions of the belt unit that contacts ends of the urging unit while the pressing unit rotates.

17. The fixing apparatus according to claim 15, further comprising:
an urging unit configured to urge a portion of the belt unit towards the pressing unit and extending in a direction of a rotational axis of the pressing unit,
wherein a length of the pressing unit in the direction is equal to or less than a length of the urging unit in the direction.

18. The fixing apparatus according to claim 17, wherein the length of the urging unit in the direction is less than a length of the belt unit in the direction.

19. The fixing apparatus according to claim 15, wherein a portion of the belt unit deforms in accordance with the shape of the pressing unit when the belt unit is pressed against the pressing unit.

20. The fixing apparatus according to claim 15, wherein the urging unit includes a shaft that extends in a direction of a rotational axis of the pressing unit, and the belt unit is configured to rotate around the shaft.
